(19) United States
(12) Patent Application Publication
(10) Pub. No.: US 2011/0149221 A1
(43) Pub. Date: Jun. 23, 2011

(54) LIQUID CRYSTAL DISPLAY DEVICE

(76) Inventor: Tatsuro Kato, Osaka (JP)

(21) Appl. No.: 13/060,556

(22) PCT Filed: Aug. 25, 2009
(86) PCT No.: PCT/JP2009/004095

§ 371 Date: Feb. 24, 2011

(30) Foreign Application Priority Data
Aug. 27, 2008 (JP) 2008 217843

(51) Int. Cl. G02F 1/1337

(52) U.S. Cl. 349/123

(57) ABSTRACT

A PSA-type liquid crystal display device is provided in which occurrence of display unevenness in the vicinity of the injection hole of the seal section is prevented.

A liquid crystal display device of the present invention includes: a pair of substrates; a liquid crystal layer interposed between the pair of substrates; a pair of electrodes opposing each other with the intervention of the liquid crystal layer; a pair of first alignment films which are respectively provided between the pair of electrodes and the liquid crystal layer; an alignment sustaining layer formed of a photopolymerized material on a surface of each of the pair of first alignment films which is closer to the liquid crystal layer, the alignment sustaining layer being configured to define a pretilt azimuth of a liquid crystal molecule of the liquid crystal layer when no voltage is applied across the liquid crystal layer; a seal section surrounding the liquid crystal layer, the seal section having an injection hole for injection of a liquid crystal material into a region surrounded by the seal section; and a sealing portion for sealing the injection hole of the seal section. The liquid crystal display device of the present invention further includes a pair of second alignment films provided in the vicinity of the sealing portion. The surface energy of each of the pair of second alignment films is higher than that of each of the pair of first alignment films.

### TECHNICAL FIELD

The present invention relates to a liquid crystal display device and specifically to a PSA-type liquid crystal display device.

### BACKGROUND ART

Liquid crystal display devices perform display by utilizing the change of the orientations of liquid crystal molecules which is caused in accordance with the level of a voltage applied across the liquid crystal layer. The orientations of the liquid crystal molecules which occur in the absence of an applied voltage across the liquid crystal layer (which are referred to as “pretilt directions”) are conventionally defined by alignment films. For example, in TN (twisted nematic) mode liquid crystal display devices, the pretilt directions of the liquid crystal molecules are defined by rubbed horizontal alignment films.

The pretilt direction is expressed by the pretilt azimuth and the pretilt angle. The pretilt azimuth refers to a component of a vector that is indicative of the orientation of a liquid crystal molecule in the liquid crystal layer in the absence of an applied voltage, the component being in a plane of the liquid crystal layer (in a plane of the substrate). The pretilt angle is an angle formed by the alignment film and the liquid crystal molecule and is determined depending primarily on a combination of the alignment film material and the liquid crystal material. In TN-mode liquid crystal display devices, the pretilt azimuths regulated by a pair of alignment films which oppose each other with the intervention of the liquid crystal layer are set perpendicular to each other. The pretilt angle is about 1° to 5°.

In recent years, as a technology for controlling the pretilt directions of the liquid crystal molecules, the PSA (Polymer Sustained Alignment) technology has been developed. The PSA technology is, for example, disclosed in Patent Documents 1 and 2. In the PSA technology, the pretilt directions of the liquid crystal molecules are controlled by means of a polymer formed in the liquid crystal layer. The polymer is formed by irradiating, after assemblage of a liquid crystal cell, a small amount of polymerizable compound (e.g., a photopolymerizable monomer) mixed in a liquid crystal material with light (typically, ultraviolet) while a predetermined voltage is applied across the liquid crystal layer. The orientations of the liquid crystal molecules maintained during the formation of the polymer are sustained (memorized) even after removal of the voltage (in the absence of an applied voltage). Thus, the PSA technology is advantageously capable of adjusting the pretilt azimuths and pretilt angles of the liquid crystal molecules by controlling, for example, an electric field generated in the liquid crystal layer. Also, the PSA technology does not require a rubbing process and is therefore suitable to formation of a vertical alignment type liquid crystal layer that has difficulty in regulating the pretilt directions by means of a rubbing process.

In fabrication of a PSA-type liquid crystal display device, as understood from the above, it is necessary to fill a region surrounded by the seal section with a liquid crystal material that contains a polymerizable compound. Known examples of the method of filling the region with the liquid crystal material include a vacuum injection method and a one drop filling method. In the case of the vacuum injection method, the liquid crystal material is injected through an injection hole formed in the seal section. After the injection of the liquid crystal material, the injection hole of the seal section is sealed with a sealant.

### CITATION LIST

### Patent Literature

Patent Document 1: Japanese Laid-Open Patent Publication No. 2002-357830
Patent Document 2: Japanese Laid-Open Patent Publication No. 2003-307720

### SUMMARY OF INVENTION

### Technical Problem

However, when the vacuum injection method is employed in fabrication of a PSA-type liquid crystal display device, display unevenness occurs in the vicinity of the injection hole so that the display quality deteriorates. This display unevenness is attributed to impurities which are dissolved from the sealant into the liquid crystal material when uncured part of the sealant comes in contact with the liquid crystal material. When the impurities are dissolved into the liquid crystal material that contains the polymerizable compound, the chemical reactivity of the polymerizable compound changes only in the impurity-dissolved region. Thus, in the impurity-dissolved region, the pretilt angle that is regulated by the polymer largely differs from that of the other region. As a result, the impurity-dissolved region is observed as having display unevenness.

The present invention was conceived in view of the above problems. One of the objects of the present invention is to provide a PSA-type liquid crystal display device in which occurrence of display unevenness in the vicinity of the injection hole of the seal section is prevented.

### Solution to Problem

A liquid crystal display device of the present invention includes: a pair of substrates; a liquid crystal layer interposed between the pair of substrates; a pair of electrodes opposing each other with the intervention of the liquid crystal layer; a pair of first alignment films which are respectively provided between the pair of electrodes and the liquid crystal layer; an alignment sustaining layer formed of a photopolymerized material on a surface of each of the pair of first alignment films which is closer to the liquid crystal layer, the alignment sustaining layer being configured to define a pretilt azimuth of a liquid crystal molecule of the liquid crystal layer when no voltage is applied across the liquid crystal layer; a seal section surrounding the liquid crystal layer, the seal section having an injection hole for injection of a liquid crystal material into a region surrounded by the seal section; and a sealing portion for sealing the injection hole of the seal section, wherein the liquid crystal display device further includes a pair of second alignment films provided in the vicinity of the sealing portion, and a surface energy of each of the pair of second alignment films is higher than that of each of the pair of first alignment films.

Another liquid crystal display device of the present invention includes: a pair of substrates; a liquid crystal layer interposed between the pair of substrates; a pair of electrodes opposing each other with the intervention of the liquid crystal layer; a pair of first alignment films which are respectively provided between the pair of electrodes and the liquid crystal layer; an alignment sustaining layer formed of a photopolymerized material on a surface of each of the pair of first alignment films which is closer to the liquid crystal layer, the alignment sustaining layer being configured to define a pretilt azimuth of a liquid crystal molecule of the liquid crystal layer when no voltage is applied across the liquid crystal layer; a seal section surrounding the liquid crystal layer, the seal section having an injection hole for injection of a liquid crystal material into a region surrounded by the seal section; and a sealing portion for sealing the injection hole of the seal section, wherein the liquid crystal display device further includes a pair of second alignment films provided in the vicinity of the sealing portion, and an ion adsorbability of each of the pair of second alignment film is higher than that of each of the pair of first alignment films.

In one preferred embodiment, the pair of first alignment films are at least inside a display region, and the pair of second alignment films are outside the display region.

In one preferred embodiment, each of the pair of second alignment films has a width of 1000 μm or more along a direction from an edge of the sealing portion which is closer to the liquid crystal layer to the display region.

In one preferred embodiment, the liquid crystal display device of the present invention further includes a shielding layer for shielding a region in which the pair of second alignment films are provided from light.

In one preferred embodiment, the pair of first alignment films extend to the vicinity of the sealing portion, and each of the pair of second alignment films is provided on a corresponding one of the pair of first alignment films.

In one preferred embodiment, the pair of second alignment films do not overlap the pair of first alignment films.

In one preferred embodiment, each of the pair of first alignment films is a vertical alignment film, and the liquid crystal layer includes liquid crystal molecules of negative dielectric anisotropy.

### Advantageous Effects of Invention

According to the present invention, a PSA-type liquid crystal display device is provided in which occurrence of display unevenness in the vicinity of the injection hole of the seal section is prevented.

### BRIEF DESCRIPTION OF DRAWINGS

FIG. 1 A cross-sectional view schematically showing the structure of one pixel included in a liquid crystal display device 100 of a preferred embodiment of the present invention. (a) shows an alignment of liquid crystal molecules in a black display state (in the absence of an applied voltage). (b) shows an alignment of liquid crystal molecules in a white display state (in the presence of an applied voltage).

FIG. 2 A top view schematically showing the liquid crystal display device 100 of a preferred embodiment of the present invention.

FIG. 3 Diagrams schematically showing the liquid crystal display device 100 of a preferred embodiment of the present invention. (a) is a cross-sectional view taken along line 3A-3A′ of FIG. 2. (b) is a cross-sectional view taken along line 3B-3B′ of FIG. 2.

FIG. 4 (a) to (d) illustrate the mechanism of generation of display unevenness in the vicinity of the injection hole of the seal section in a conventional PSA-type liquid crystal display device.

FIG. 5 An enlarged view of the vicinity of the injection hole formed in the seal section of the liquid crystal display device 100 of a preferred embodiment of the present invention.

FIG. 6 A cross-sectional view schematically showing the liquid crystal display device 100 of a preferred embodiment of the present invention.

FIG. 7 (a) and (b) are cross-sectional views schematically showing the liquid crystal display device 100 of a preferred embodiment of the present invention.

FIG. 8 Diagrams schematically showing a comparative example liquid crystal display device 600. (a) is a top view. (b) is a cross-sectional view taken along line 8A-8A′ of (a).

FIG. 9 (a) and (b) are cross-sectional views schematically showing another liquid crystal display device 200 of a preferred embodiment of the present invention.

### DESCRIPTION OF EMBODIMENTS

Hereinafter, an embodiment of the present invention will be described with reference to the drawings. Note that the present invention is not limited to the embodiment which will be described below.

[Basic Configuration and Principle of Operation of PSA-type Liquid Crystal Display Device]

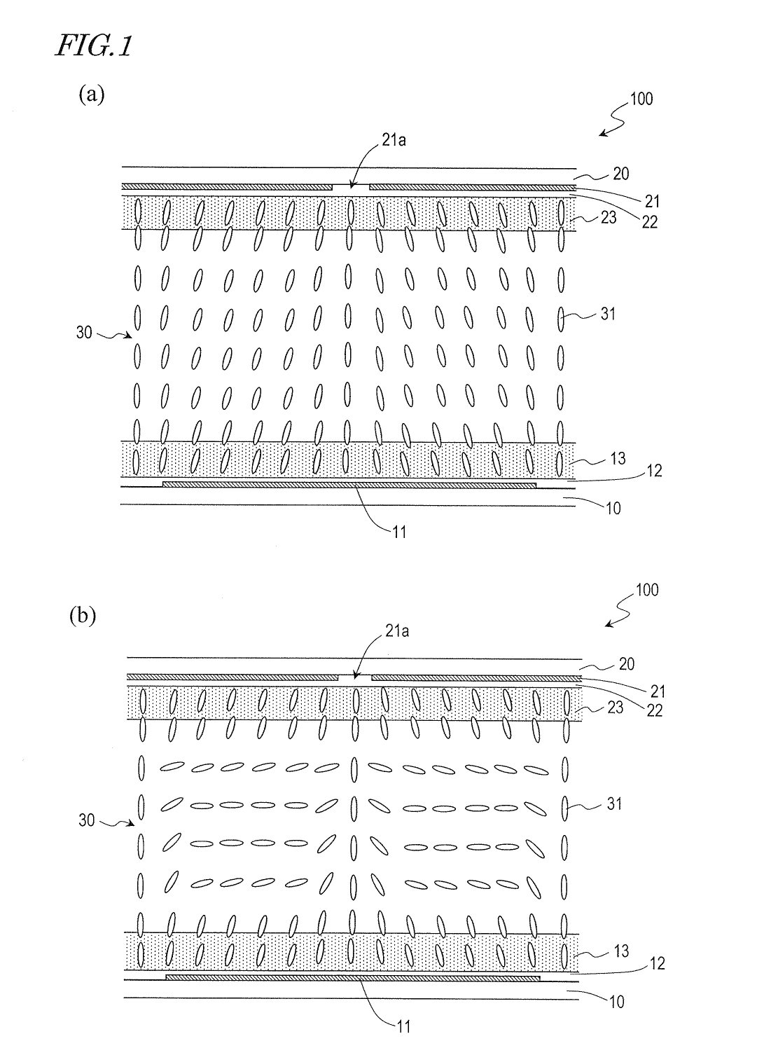

First, the basic configuration and the principle of operation of PSA-type liquid crystal display devices are described with reference to FIG. 1. FIG. 1 is a cross-sectional view schematically showing the structure of one pixel included in a liquid crystal display device 100 of the present embodiment. FIG. 1(a) shows together an alignment of liquid crystal molecules in a black display state (in the absence of an applied voltage). FIG. 1(b) shows together an alignment of liquid crystal molecules in a white display state (in the presence of an applied voltage). Note that the liquid crystal display device 100 shown herein as an example is a vertical alignment (VA) mode liquid crystal display device which is configured to perform display in a normally black mode, to which the present invention is however not limited.

The liquid crystal display device 100 includes a pair of substrates 10 and 20 and a liquid crystal layer 30 interposed between the substrates 10 and 20. A pair of polarizing plates (not shown) are provided on the outer sides of the pair of substrates 10 and 20 so as to be in a crossed Nicols arrangement.

Each of the pixels of the liquid crystal display device 100 includes the liquid crystal layer 30, and a pixel electrode 11 and a counter electrode 21 which oppose each other with the intervention of the liquid crystal layer 30. Here, the counter electrode 21 has an opening 21a (portion not including a conductive film). The liquid crystal layer includes liquid crystal molecules 31 of negative dielectric anisotropy.

A pair of vertical alignment films 12 and 22 are respectively provided between the pixel electrode 11 and the liquid crystal layer 30 and between the counter electrode 21 and the liquid crystal layer 30. Surfaces of the vertical alignment films 12 and 22 which are closer to the liquid crystal layer 30 are respectively provided with alignment sustaining layers 13 and 23 formed of a photopolymerized material. As will be described later, the alignment sustaining layers 13 and 23 define the pretilt azimuth of the liquid crystal molecules 31 of the liquid crystal layer 30 when no voltage is applied across the liquid crystal layer 30.

The alignment sustaining layers 13 and 23 are formed by, after formation of a liquid crystal cell, polymerizing a photopolymerizable compound contained in a prepared liquid crystal material while a voltage is applied across the liquid crystal layer 30. Note that, for the sake of convenience, each of the alignment sustaining layers 13 and 23 in FIG. 1 is shown as a continuous film-like layer. However, the alignment sustaining layers 13 and 23 are not limited to such a form. Each of the alignment sustaining layers 13 and 23 may be constituted of a plurality of pieces (islands) that are discretely formed.

Before the polymerization of the photopolymerizable compound, the alignment of the liquid crystal molecules 31 is controlled by the vertical alignment films 12 and 22 so that the liquid crystal molecules 31 are oriented vertically to the substrate surface. When a white display voltage is applied, the liquid crystal molecules 31 result in an alignment where they are inclined in predetermined directions according to an oblique electric field generated at an edge portion of the pixel electrode 11 and an oblique electric field generated near an opening 21a of the counter electrode 21 as shown in FIG. 1(b). The alignment sustaining layers 13 and 23, which are formed under application of the white display voltage, function to sustain (memorize) an alignment of the liquid crystal molecules 31 which occurs under application of the white display voltage across the liquid crystal layer 30 even after removal of the voltage (in the absence of an applied voltage) as shown in FIG. 1(a).

The liquid crystal display device 100 of an embodiment of the present invention has the alignment sustaining layers 13 and 23 and therefore exhibits an alignment of the liquid crystal molecules pretilted in predetermined directions as shown in FIG. 1(a) even in the absence of an applied voltage. The alignment which occurs in this condition conforms to the alignment of the liquid crystal molecules 31 which occurs in a white display state (in the presence of an applied voltage) as shown in FIG. 1(b). As a result, a stable alignment can be achieved, and the response characteristics, etc., can be improved.

In the example described herein, an opening 21a is provided in the counter electrode 21 in order to control the orientations of the liquid crystal molecules 31. However, the method for controlling the orientations of the liquid crystal molecules 31 in the formation of the alignment sustaining layers 13 and 23 is not limited to this example. For example, a protrusion may be provided on the counter electrode 21 instead of the opening 21a. An alignment regulating force produced by an oblique electric field generated at an edge portion of the pixel electrode 11 and an alignment regulating force produced by an opening 21a formed in the counter electrode 21 (or the protrusion provided on the counter electrode 21) are used in combination, whereby liquid crystal domains which exhibit, for example, an axially symmetric alignment (radially inclined alignment), can be formed. A vertical alignment mode in which liquid crystal domains of an axially symmetric alignment is formed is referred to as a CPA (Continuous Pinwheel Alignment) mode.

The CPA mode is disclosed in, for example, Japanese Laid-Open Patent Publication No. 2002-202511. Another known vertical alignment mode is a MVA (Multi-domain Vertical Alignment) mode such as disclosed in Patent Document 1. The alignment regulating structures for use in the MVA mode (a protrusion provided on the electrode, a slit formed in the electrode, etc.) may be used. In the MVA mode, four types of liquid crystal domains among which the azimuth of the orientations of the liquid crystal molecules 31 is different (typically, by about 90°).

The alignment sustaining layers 13 and 23 can be formed according to any of various known methods such as disclosed in Patent Documents 1 and 2 and, for example, can also be formed as described below.

A liquid crystal cell is fabricated using a material in which a photopolymerizable compound of a predetermined amount is mixed in a nematic liquid crystal material of negative dielectric anisotropy. The photopolymerizable compound may preferably be a monomer or oligomer which has a radically-polymerizable functional group, such as an acrylate group, a methacrylate group, a vinyl group, or the like. In terms of reactivity, a monomer or oligomer which has an acrylate group or a methacrylate group is more preferable. Among such examples, a polyfunctional group is preferable. By using a material which has a liquid crystal skeleton as the photopolymerizable compound, the alignment of the liquid crystal molecules 31 can be sustained more stably. Especially, a ring system or condensed ring system described in Patent Document 2 to which an acrylate group or a methacrylate group is directly bonded is preferable.

Then, the liquid crystal layer 30 of this liquid crystal cell (including the above-described photopolymerizable compound) is irradiated with ultraviolet rays while a predetermined voltage is applied across the liquid crystal layer. Application of the voltage across the liquid crystal layer 30 causes the liquid crystal molecules 31 to have a predetermined alignment according to electric fields generated between the counter electrode 21 and the pixel electrode 11. The irradiation of ultraviolet rays causes polymerization of the photopolymerizable compound so that a photopolymerized material is produced. The photopolymerized material forms the alignment sustaining layers 13 and 23 on the vertical alignment films 12 and 22 for fixing the alignment of the liquid crystal molecules 31. A series of steps for photopolymerizing a photopolymerizable compound while a predetermined voltage which is not lower than the white display voltage is applied to form alignment sustaining layers 13 and 23 is sometimes referred to as “PSA process”. In this way, the alignment sustaining layers 13 and 23 can be formed.

[Arrangement of Seal section, Injection Hole, Sealing Portion, and Additional Alignment Films]

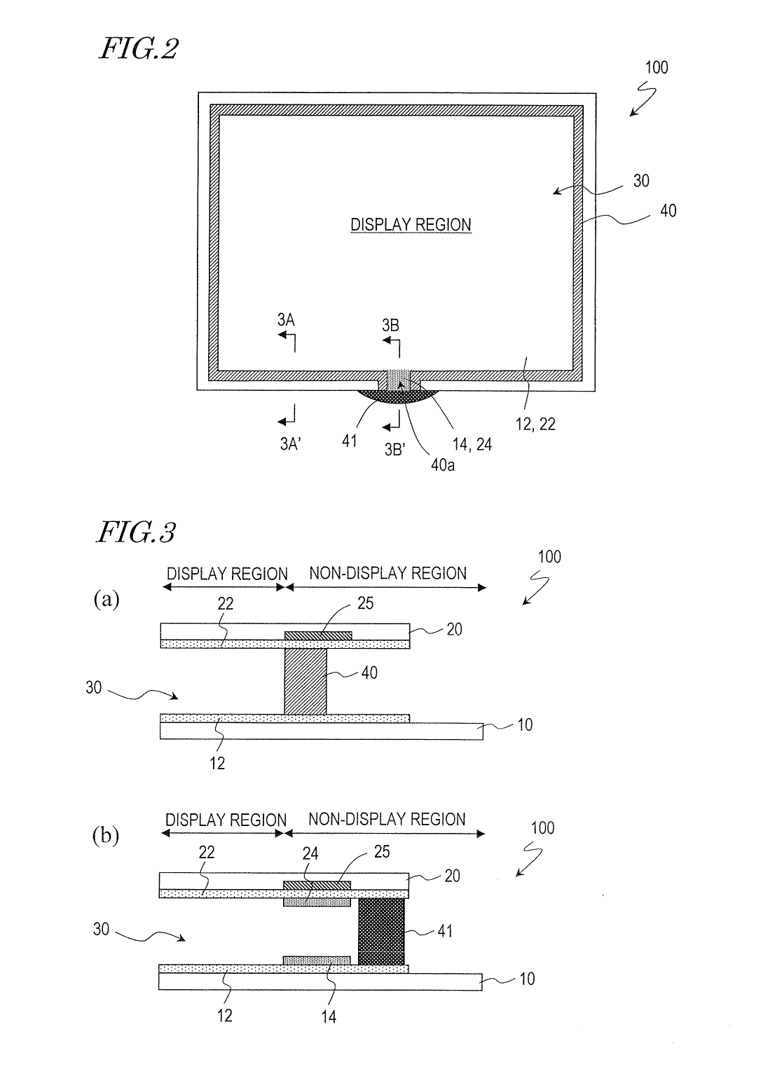

Now, the structure of the liquid crystal display device 100 of the present embodiment is described in more detail with reference to FIG. 2 and FIG. 3. FIG. 2 is a top view of the liquid crystal display device 100 which is seen in a direction normal to the substrate. FIG. 3(a) and FIG. 3(b) are cross-sectional views respectively taken along line 3A-3A′ and line 3B-3B′ of FIG. 2.

The liquid crystal display device 100 includes a seal section 40 surrounding the liquid crystal layer 30 as shown in FIG. 2 and FIG. 3(a). The seal section 40 is provided in a region outside a display region that includes a plurality of pixels, which is referred to as non-display region. Typically, the seal section 40 is formed of a sealant which contains a thermosetting resin (thermosetting sealant) or a sealant which contains a photocurable resin (photocurable sealant).

The seal section 40 has an injection hole 40a through which the liquid crystal material is to be injected into a region surrounded by the seal section 40 as shown in FIG. 2. The injection hole 40a is provided in one side of the seal section 40 that has a generally rectangular shape. The injection hole 40a is sealed with a sealing portion 41. The sealing portion 41 is typically made of a sealant which contains a photocurable resin.

The liquid crystal display device 100 of the present embodiment includes a pair of additional vertical alignment films 14 and 24 which are provided in the vicinity of the sealing portion 41 as shown in FIG. 2 and FIG. 3(b). Hereinafter, the vertical alignment films 12 and 22 that have been previously described are referred to as “first alignment films”, while the additional vertical alignment films 14 and 24 that are provided in the vicinity of the sealing portion 41 are referred to as “second alignment films”.

The first alignment films 12 and 22 are mainly inside the display region. On the other hand, the second alignment films 14 and 24 are outside the display region (i.e., inside the non-display region). In the structure illustrated in FIG. 3(b), both the first alignment films 12 and 22 extend out of the display region. The second alignment films 14 and 24 are respectively stacked on those marginal parts of the first alignment films 12 and 22 outside the display region. A shielding layer (black matrix) 25 is provided to shield a region in which the second alignment films 14 and 24 are provided from light. The first alignment films 12 and 22 and the second alignment films 14 and 24 have different surface states. Specifically, the surface energy of each of the second alignment films 14 and 24 is higher than that of each of the first alignment films 12 and 22.

As described above, in the liquid crystal display device 100 of the present embodiment, the second alignment films 14 and 24, which have a higher surface energy than the first alignment films 12 and 22, are provided in the vicinity of the sealing portion 41. In other words, two types of alignment films which have different surface states (surface energies) are provided on one substrate.

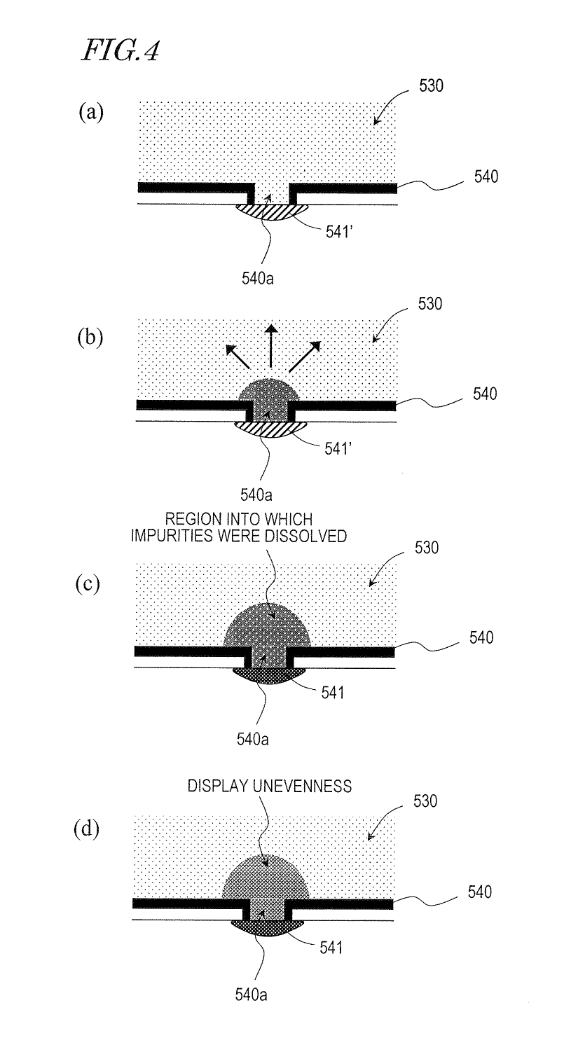

Now, the mechanism of generation of display unevenness in the vicinity of the injection hole of the seal section in a conventional PSA-type liquid crystal display device (i.e., a liquid crystal display device in which only a single type of alignment film is provided on one substrate) is described with reference to FIG. 4. FIGS. 4(a) to 4(d) show the vicinity of the injection hole of the conventional PSA-type liquid crystal display device, illustrating the progress from application of the sealant to the PSA process in order of time.

As shown in FIG. 4(a), after a liquid crystal material (containing a photopolymerizable compound) is injected into a liquid crystal cell to form a liquid crystal layer 530, a sealant 541′ is applied to close an injection hole 540a of a seal section 540. The applied sealant 541′ may be cured by light irradiation. If irradiated with ultraviolet rays as is a common liquid crystal display device, the photopolymerizable compound contained in the liquid crystal layer 530 may also be irradiated with a small amount of ultraviolet rays to cause a reaction. To avoid this, in the PSA-type liquid crystal display devices, the sealant 541′ is cured by visible light irradiation.

However, during the curing process, impurities (which are estimated to include an initiator or the like) are dissolved from the sealant 541′ into the liquid crystal layer 530 as shown in FIG. 4(b). On completion of the curing of the sealant 541′, a sealing portion 541 is formed as shown in FIG. 4(c). At this point in time, impurities have already been dissolved into part of the liquid crystal layer 530 in the vicinity of the injection hole 540a.

Although the photopolymerizable compound contained in the liquid crystal layer 530 intrinsically reacts only with ultraviolet rays, visible light irradiation for curing of the sealant 541′ causes a reaction of the photopolymerizable compound in the vicinity of the injection hole 540a due to the initiator included in the impurities (an initiator which may react with light within the visible light range). Therefore, in the vicinity of the injection hole 540a, large part of the photopolymerizable compound has already undergone a reaction before the PSA process, so that the pretilt angle in this region is different from that of the other region. Thus, as shown in FIG. 4(d), display unevenness occurs in a semicircular area in the vicinity of the injection hole 540a. With the view of preventing occurrence of such unevenness, using a sealant which has a higher viscosity and employing a process in which the sealant is cured as soon as possible after its application are under study, although a sealant or process which is capable of completely preventing occurrence of unevenness has not yet been developed as of now.

On the other hand, in the liquid crystal display device 100 of the present embodiment, the second alignment films 14 and 24, which have a higher surface energy than the first alignment films 12 and 22, are provided in the vicinity of the sealing portion 41. Therefore, the impurities dissolved from the sealant that is to form the sealing portion 41 are more likely to be adsorbed by the second alignment films 14 and 24 than by the first alignment films 12 and 22. Thus, the impurities are more likely to reside in the vicinity of the sealing portion 41 and less likely to move into the display region. As a matter of course, in the region in which the second alignment films 14 and 24 are provided, the impurities are adsorbed so that the pretilt angle can be different from that of the other region. However, the region in which the second alignment films 14 and 24 are provided would not be perceived as display unevenness because the region in the vicinity of the sealing portion 41 is a non-display region (which is, for example, shielded from light by the shielding layer 25 as shown in FIG. 3(b)). Thus, in the liquid crystal display device 100 of the present embodiment, occurrence of display unevenness in the vicinity of the injection hole 40a is prevented, so that excellent display characteristics can be obtained.

The reason why the impurities are more likely to be adsorbed by the alignment film as the surface energy of the alignment film increases is that the coulombic electrostatic force increases as the surface energy increases, so that ionic impurities are more strongly attracted by the alignment film. The surface energy of the alignment film can be evaluated by, for example, measuring the surface tension of the alignment film. The surface tension of the alignment film can be calculated from a contact angle of a liquid droplet on the surface of the alignment film.

The material of the first alignment films 12 and 22 and the material of the second alignment films 14 and 24 may be any of the combinations shown in TABLE 1 below, #1 to #4.

TABLE 1

| | First Alignment Film | Second Alignment Film |
|---|---|---|
| #1 | SE7492 | SE150 (manufactured by Nissan |
| | (manufactured by Nissan | Chemical Industries, Ltd.) |
| #2 | Chemical Industries, | SE2170 (manufactured by |
| | Ltd.) | Nissan Chemical Industries, |
| | | Ltd.) |
| #3 | | SE130 (manufactured by Nissan |
| | | Chemical Industries, Ltd.) |
| #4 | | SE3140 (manufactured by |
| | | Nissan Chemical Industries, |
| | | Ltd,) |

To more assuredly prevent the impurities from moving into the display region, referring to FIG. 5, the width of the second alignment films 14 and 24 along a direction from an edge of the sealing portion 41 which is closer to the liquid crystal layer 30 to the display region, W, is preferably larger than a certain value. Specifically, the width W is preferably 1000 μm or more.

In the above-described example of the present embodiment, the first alignment films 12 and 22 extend to the vicinity of the sealing portion 41 as shown in FIG. 3. However, the first alignment films 12 and 22 may be at least inside the display region and do not need to extend out of the display region (i.e., do not need to extend into the non-display region).

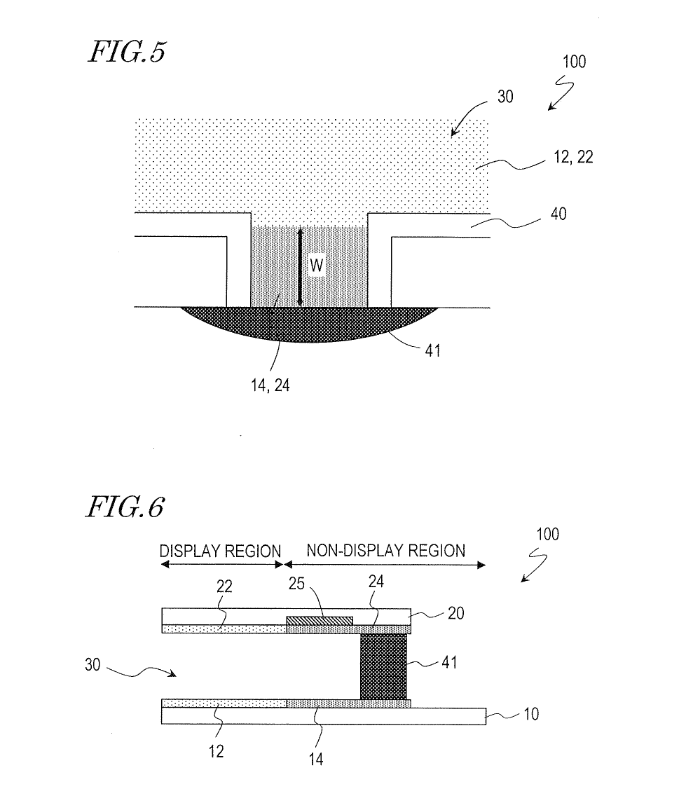

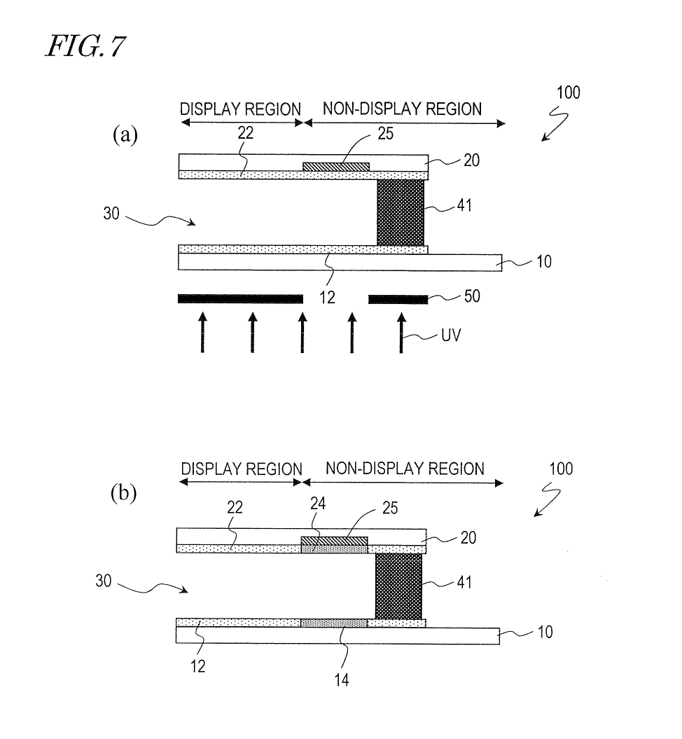

For example, as shown in FIG. 6, the first alignment films 12 and 22 may be provided only inside the display region. In this case, the second alignment films 14 and 24 do not overlap the first alignment films 12 and 22. Such an arrangement can be realized by patterning the alignment film material for the first alignment films 12 and 22 and the alignment film material for the second alignment films 14 and 24 which are applied over the substrates 10 and 20. Alternatively, as shown in FIG. 7(a), a single type of alignment film material may be applied over the entire surface of respective one of the substrates 10 and 20 before ultraviolet irradiation is selectively performed in the vicinity of the sealing portion 41. The selective ultraviolet irradiation in the vicinity of the sealing portion 41 may be carried out with the use of a photomask 50 as illustrated in the drawing, for example. In the region irradiated with ultraviolet rays, the alignment films have an increased surface energy. Therefore, as shown in FIG. 7(b), parts of the alignment films in the vicinity of the sealing portion 41 constitute the second alignment films 14 and 24 that have a higher surface energy, while the other parts constitute the first alignment films 12 and 22 that have a lower surface energy.

The structure shown in FIG. 3(b) in which the second alignment films 14 and 24 are stacked on the first alignment films 12 and 22 can simply be realized by additionally and partially forming the second alignment film 14. Therefore, this structure has an advantage that the manufacturing process is relatively simple. On the other hand, the structures shown in FIG. 6 and FIG. 7(b) in which the second alignment films 14 and 24 do not overlap the first alignment films 12 and 22 can have a generally uniform cell thickness. Thus, degradation in display quality (e.g., leakage light) which would occur due to the nonuniform cell thickness (i.e., the nonuniform retardation of light which is caused by the liquid crystal layer 30) can advantageously be prevented.

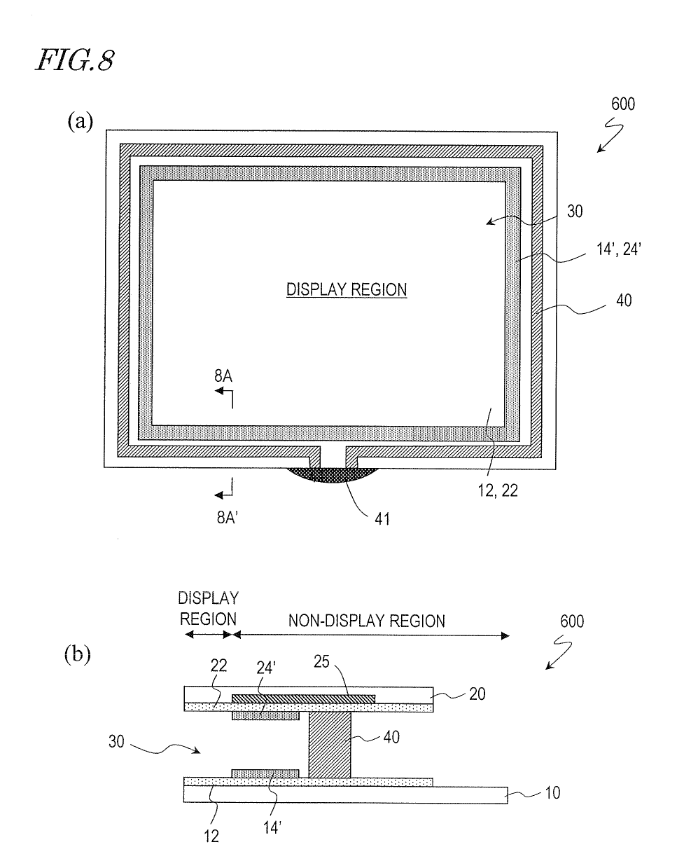

Note that, in the liquid crystal display device 100 of the present embodiment, the second alignment films 14 and 24 are provided in the vicinity of the sealing portion 41. To prevent the impurities from moving into the display region, however, providing additional alignment films that have a higher surface energy so as to enclose the entire display region, rather than being provided in the vicinity of the sealing portion, may be possible. A comparative example liquid crystal display device 600 which has such a structure is shown in FIGS. 8(a) and 8(b). The liquid crystal display device 600 includes additional alignment films 14′ and 24′ which are provided so as to surround the perimeter of the vertical alignment films 12 and 22 provided inside the display region. The surface energy of the additional alignment films 14′ and 24′ is higher than that of the vertical alignment films 12 and 22 provided inside the display region. Even such a structure can prevent the impurities from moving into the display region, but in this case, as seen from FIG. 8(b), the region in which the additional alignment films 14′ and 24′ are provided (a region surrounding the four sides of the display region) constitutes a non-display region, so that the non-display region (which is herein called “frame region”) becomes large.

On the other hand, in the liquid crystal display device 100 of the present embodiment, the second alignment films 14 and 24 are provided only in the vicinity of the sealing portion 41, rather than surrounding the entire display region. Thus, occurrence of display unevenness can be prevented, without substantially increasing the non-display region.

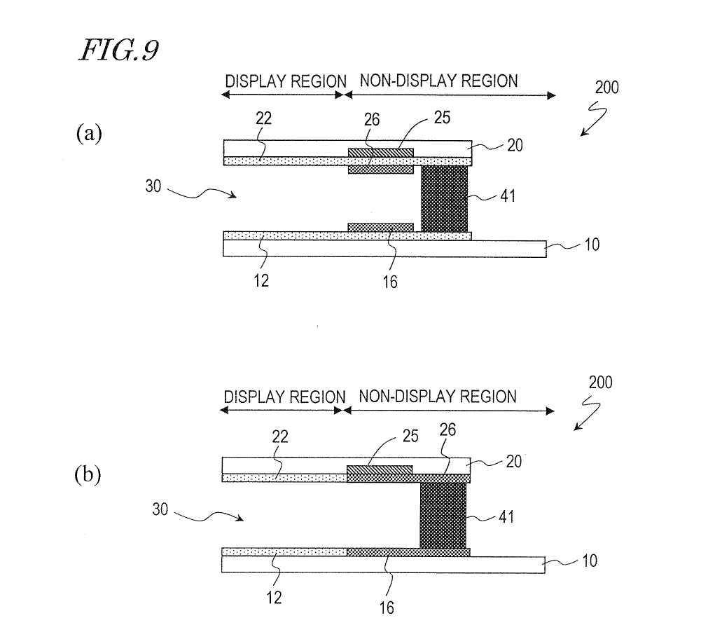

In the liquid crystal display device 100 shown in FIG. 2, the second alignment films 14 and 24 which have a higher surface energy than the first alignment films 12 and are provided. However, alternatively, alignment films which have higher ion adsorbability than the first alignment films 12 and 22 may be provided in the vicinity of the sealing portion 41. FIG. 9(a) schematically shows another liquid crystal display device 200 of the present embodiment.

The liquid crystal display device 200 includes second alignment films 16 and 26 in the vicinity of the sealing portion 41. Each of these second alignment films 16 and 26 has higher ion adsorbability than each of the first alignment films 12 and 22. Therefore, the impurities dissolved from the sealant that is to form the sealing portion 41 are more likely to be adsorbed by the second alignment films 16 and 26 than by the first alignment films 12 and 22. Thus, the impurities are more likely to reside in the vicinity of the sealing portion 41 and less likely to move into the display region. As a matter of course, in the region in which the second alignment films 16 and 26 are provided, the impurities are adsorbed so that the pretilt angle can be different from that of the other region. However, the region in which the second alignment films 16 and 26 are provided would not be perceived as display unevenness because the region in the vicinity of the sealing portion 41 is a non-display region (which is shielded from light by the shielding layer 25 as shown in FIG. 9(a)). Thus, in the liquid crystal display device 200, occurrence of display unevenness in the vicinity of the injection hole is also prevented, so that excellent display characteristics can be obtained.

The ion adsorbability of the alignment films can be evaluated by, for example, measuring the specific resistance of the liquid crystal layer interposed between the alignment films. The material of the first alignment films 12 and 22 and the material of the second alignment films 16 and 26 may be, for example, combination #5 shown in TABLE 2 below.

TABLE 2

| | First Alignment Film | Second Alignment Film |
|---|---|---|
| #5 | SE2170 | AL1051 |
| | (manufactured by Nissan | (manufactured by |
| | Chemical Industries, | JSR Corporation) |
| | Ltd.) | |

Note that, in the example shown in FIG. 9(a), the first alignment films 12 and 22 extend out of the display region, and the second alignment films 16 and 26 are respectively stacked on those marginal parts of the first alignment films 12 and 22 outside the display region, although the second alignment films 16 and 26 may not overlap the first alignment films 12 and 22 as shown in FIG. 9(b).

In the above-described example of the present embodiment, the seal section 40 has only one injection hole 40a. However, the seal section 40 may have a plurality of (or “two or more”) injection holes 40a. In this case, plural ones of the sealing portion 41 are provided so as to seal the plurality of injection holes 40a. Thus, the second alignment films 14 and 24 (or “16 and 26”) may be provided in the vicinity of each of the sealing portions 41.

### INDUSTRIAL APPLICABILITY

According to the present invention, a PSA-type liquid crystal display device is provided in which occurrence of display unevenness in the vicinity of the injection hole of the seal section is prevented. The present invention is suitably applicable to various display modes of liquid crystal display devices, especially suitably applicable to liquid crystal display devices of vertical alignment modes, such as CPA mode and MVA mode.

### REFERENCE SIGNS LIST

10, 20 substrate
11 pixel electrode
12, 22 vertical alignment film (first alignment film)
13, 23 alignment sustaining layer
14, 24 additional vertical alignment film (second alignment film)
16, 26 additional vertical alignment film (second alignment film)
21 counter electrode
21a opening
25 shielding layer
30 liquid crystal layer
31 liquid crystal molecule
40 seal section
41 sealing portion

1. A liquid crystal display device, comprising:
a pair of substrates;
a liquid crystal layer interposed between the pair of substrates;
a pair of electrodes opposing each other with the intervention of the liquid crystal layer;
a pair of first alignment films which are respectively provided between the pair of electrodes and the liquid crystal layer;
an alignment sustaining layer formed of a photopolymerized material on a surface of each of the pair of first alignment films which is closer to the liquid crystal layer, the alignment sustaining layer being configured to define a pretilt azimuth of a liquid crystal molecule of the liquid crystal layer when no voltage is applied across the liquid crystal layer;
a seal section surrounding the liquid crystal layer, the seal section having an injection hole for injection of a liquid crystal material into a region surrounded by the seal section; and
a sealing portion for sealing the injection hole of the seal section, wherein the liquid crystal display device further comprises a pair of second alignment films provided in the vicinity of the sealing portion, and
a surface energy of each of the pair of second alignment films is higher than that of each of the pair of first alignment films.

2. A liquid crystal display device, comprising:
a pair of substrates;
a liquid crystal layer interposed between the pair of substrates;
a pair of electrodes opposing each other with the intervention of the liquid crystal layer;
a pair of first alignment films which are respectively provided between the pair of electrodes and the liquid crystal layer;
an alignment sustaining layer formed of a photopolymerized material on a surface of each of the pair of first alignment films which is closer to the liquid crystal layer, the alignment sustaining layer being configured to define a pretilt azimuth of a liquid crystal molecule of the liquid crystal layer when no voltage is applied across the liquid crystal layer;
a seal section surrounding the liquid crystal layer, the seal section having an injection hole for injection of a liquid crystal material into a region surrounded by the seal section; and
a sealing portion for sealing the injection hole of the seal section, wherein the liquid crystal display device further comprises a pair of second alignment films provided in the vicinity of the sealing portion, and
an ion adsorbability of each of the pair of second alignment films is higher than that of each of the pair of first alignment films.

3. The liquid crystal display device of claim 1, wherein the pair of first alignment films are at least inside a display region, and
the pair of second alignment films are outside the display region.

4. The liquid crystal display device of claim 3, wherein each of the pair of second alignment films has a width of 1000 μm or more along a direction from an edge of the sealing portion which is closer to the liquid crystal layer to the display region.

5. The liquid crystal display device of claim 3, further comprising a shielding layer for shielding a region in which the pair of second alignment films are provided from light.

6. The liquid crystal display device of claim 3, wherein the pair of first alignment films extend to the vicinity of the sealing portion, and
each of the pair of second alignment films is provided on a corresponding one of the pair of first alignment films.

7. The liquid crystal display device of claim 3, wherein the pair of second alignment films do not overlap the pair of first alignment films.

8. The liquid crystal display device of claim 1, wherein each of the pair of first alignment films is a vertical alignment film, and
the liquid crystal layer includes liquid crystal molecules of negative dielectric anisotropy.

9. The liquid crystal display device of claim 2, wherein the pair of first alignment films are at least inside a display region, and
the pair of second alignment films are outside the display region.

10. The liquid crystal display device of claim 9, wherein each of the pair of second alignment films has a width of 1000 μm or more along a direction from an edge of the sealing portion which is closer to the liquid crystal layer to the display region.

11. The liquid crystal display device of claim 9, further comprising a shielding layer for shielding a region in which the pair of second alignment films are provided from light.

12. The liquid crystal display device of claim 9, wherein the pair of first alignment films extend to the vicinity of the sealing portion, and
each of the pair of second alignment films is provided on a corresponding one of the pair of first alignment films.

13. The liquid crystal display device of claim 9, wherein the pair of second alignment films do not overlap the pair of first alignment films.

14. The liquid crystal display device of claim 2, wherein each of the pair of first alignment films is a vertical alignment film, and
the liquid crystal layer includes liquid crystal molecules of negative dielectric anisotropy.
